(19) United States
(12) Patent Application Publication
(10) Pub. No.: US 2009/0266217 A1
(43) Pub. Date: Oct. 29, 2009

(54) SHEET CUTTING DEVICE AND CUTTING METHOD

(75) Inventors: Hideaki Nonaka, Tokyo (JP); Kenji Kobayashi, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: LINTEC CORPORATION, Tokyo (JP)

(21) Appl. No.: 12/097,025

(22) PCT Filed: Dec. 7, 2006
(86) PCT No.: PCT/JP2006/324437

§ 371 Date: Jun. 11, 2008

(30) Foreign Application Priority Data
Jan. 18, 2006 (JP) 2006-009654

(51) Int. Cl. B26D 3/10; G06F 19/00

(52) U.S. Cl. 83/881; 700/121; 83/49

(57) ABSTRACT

There is provided a method of cutting a sheet S stuck on a semiconductor wafer W having a notch N in an outer circumferential portion in accordance with a plane shape of the semiconductor wafer W. The cutting operation is carried out by using a sheet cutting device 10 mounted with a cutter blade 13 on its free-end side. The cutter blade is arranged so as to be positioned at a first insertion depth via a displacement mechanism when cutting the sheet S in an area other than an area formed with a notch N; and at a second insertion depth shallower than the first insertion depth to cut the sheet S in an area formed with the notch N.

### TECHNICAL FIELD

The present invention relates to a sheet cutting device and a cutting method, in particular to a sheet cutting device and a cutting method capable of cutting a sheet along a preset track, and continuously performing the sheet cutting precisely along a minute shape.

### BACKGROUND ART

Conventionally, a semiconductor wafer (hereinafter, simply referred to as “wafer”) is stuck with a protective sheet for protecting a circuit surface thereof, or stuck with a heat sensitive adhesive sheet on a rear or front surface thereof.

As a sticking method of such sheets, there is known such a method that, using a raw sheet that is temporarily stuck with a strip of a sheet on a strip of a release liner, the sheet is peeled off from the release liner and then the sheet is stuck onto a wafer, and then cut off along the outer circumference of the wafer (for example, refer to patent document 1).

[Patent document 1] Japanese Patent Application

### DISCLOSURE OF THE INVENTION

### Problem To Be Solved by the Invention

However, in the cutting method disclosed in the patent document 1, a cutter blade is arranged to move to cut the sheet along the outer circumference of a wafer in a state that an insertion depth of the cutter blade is kept at a fixed level with respect to a sheet. Therefore, in a case where a V-shaped notch indicating a crystal orientation of the wafer is formed in the outer circumference thereof, since the notch is extremely small with respect to an entire plane area of the wafer, there reside the following disadvantages; i.e., it is extremely difficult to move the cutter blade along an outer edge of the notch, and accordingly the sheet is hardly cut along the edge formed with the V-notch; and when the sheet is forcedly cut, the wafer is accidentally broken.

On the other hand, it is conceivable to set the insertion depth of the cutter blade shallow with respect to the sheet from the beginning of the cutting operation. However, when the cutting of the sheet is carried out with a shallow insertion depth, since the rigidity in a front end area of the cutter blade is relatively low compared to the rigidity in a base portion area thereof, the durability of the blade cannot be maintained for along period of time; and as a result, failures of sheet cutting frequently occur.

[Object of the Invention]

The present invention has been proposed in view of the above disadvantages. An object of the present invention is to provide a sheet cutting device and a cutting method capable of minute cutting by means of changing the insertion depth of the cutter blade in accordance with the cutting area of the sheet and maintaining the durability of the cutter blade.

### Means for Solving the Problems

In order to achieve the above object, the present invention employs such an arrangement that a sheet cutting device for cutting a sheet stuck on an object in accordance with a plane shape of the object, comprising:
a support table for supporting the object;
a cutting robot equipped with a cutter blade at a free-end side for cutting the sheet by moving the cutter blade along a predetermined track; and
a displacement mechanism for changing an insertion depth of the cutter blade, wherein
the cutter blade cuts the sheet by changing the insertion depth via the displacement mechanism when cutting a predetermined specific area corresponding to the object.

The present invention may employ such an arrangement that the cutting robot is a multi-joint robot having a plurality of joints numerically controlled to function as the displacement mechanism.

Also, the cutter blade may have such arrangement that the cutter blade includes a blade holder and a blade supported by the blade holder, the blade holder being equipped with the displacement mechanism arranged so as to be capable of displacing the blade in a direction where the insertion depth is changed.

Further, the present invention employs such a method that a sheet cutting method of cutting a sheet stuck on an object in accordance with a plane shape of the object, in which
using a cutting robot having a cutter blade mounted on a free-end side thereof, wherein
the cutter blade cuts the sheet by means of changing an insertion depth of the cutter blade when cutting a predetermined specific area corresponding to the object.

Furthermore, the present invention employs such a method that a sheet cutting method of cutting a sheet stuck on a semiconductor wafer having a notch in an outer circumferential portion in accordance with a plane shape of the semiconductor wafer, in which
using a cutting robot having a cutter blade mounted on a free-end side thereof, wherein
the cutter blade cuts the sheet at a first insertion depth when cutting the sheet along an outer edge of the wafer other than an edge formed with the notch, and cuts the sheet at a second insertion depth shallower than the first insertion depth when cutting the sheet along an edge formed with the notch.

The sheet cutting method preferably employs such a method that the cutting operation is continuously carried out along a track having a substantially closed loop without pulling out and reinstalling the cutter blade.

### Effect of the Invention

According to the present invention, when cutting the sheet along a predetermined specific area corresponding to an object such as a semiconductor wafer, for example, an area formed with a notch, an area of minimum width of the cutter blade can be used by changing the insertion depth of the cutter blade to be shallow. Owing to this, the sheet can be cut while achieving a movement of the cutter blade along a minute shape.

On the other hand, when cutting the sheet in other areas excluding the notched area or the like, the insertion depth of the cutter blade is changed in a direction to be deeper to cut the sheet using an area with a high rigidity of the cutter blade; thereby, the cutter blade can be prevented from being damaged and the durability thereof can be maintained.

By continuously changing the insertion depth of the cutter blade in accordance with the shape of the object without pulling out and reinstalling the cutter blade, the sheet can be cut in a track of so-called single stroke of drawing brush; thereby the sheet can be cut exquisitely with no step, and further, the cutting efficiency can be maintained satisfactory.

### BRIEF DESCRIPTION OF THE DRAWINGS

FIG. 1 is a front view schematically showing a sheet cutting device and a table in accordance with an embodiment.

FIG. 2 is an enlarged perspective view showing a free-end side of the sheet cutting device.

FIG. 3 is an enlarged perspective view of a cutter blade.

FIG. 4 is an explanatory view of a sheet cutting operation carried out keeping a toe-in angle.

FIG. 5 is an explanatory view of a sheet cutting operation carried out keeping a camber angle.

FIG. 6 is an explanatory view showing a position (a first position) of the blade in a sheet cutting operation in an area other than a notched area.

FIG. 7 is an explanatory view showing a position (a second position) of the blade in a sheet cutting operation in a notched area.

FIG. 8 is an explanatory view of a modification equivalent to FIG. 6.

FIG. 9 is an explanatory view of a modification equivalent to FIG. 7.

FIG. 10 is a perspective view schematically showing a modification of a cutter blade provided with a displacement mechanism.

### EXPLANATION OF NUMERAL REFERENCE

10: sheet cutting device
11: table
12: robot body
13: cutter blade
13A: blade holder
13B: blade
13F: blade edge
13E: front end portion
15A to 15F: first to sixth arms (displacement mechanism)
N: notch (specific area)
S: sheet
W: semiconductor wafer (object)

### BEST MODE FOR CARRYING OUT THE INVENTION

Hereinafter, embodiments of the present invention will be described with reference to the drawings.

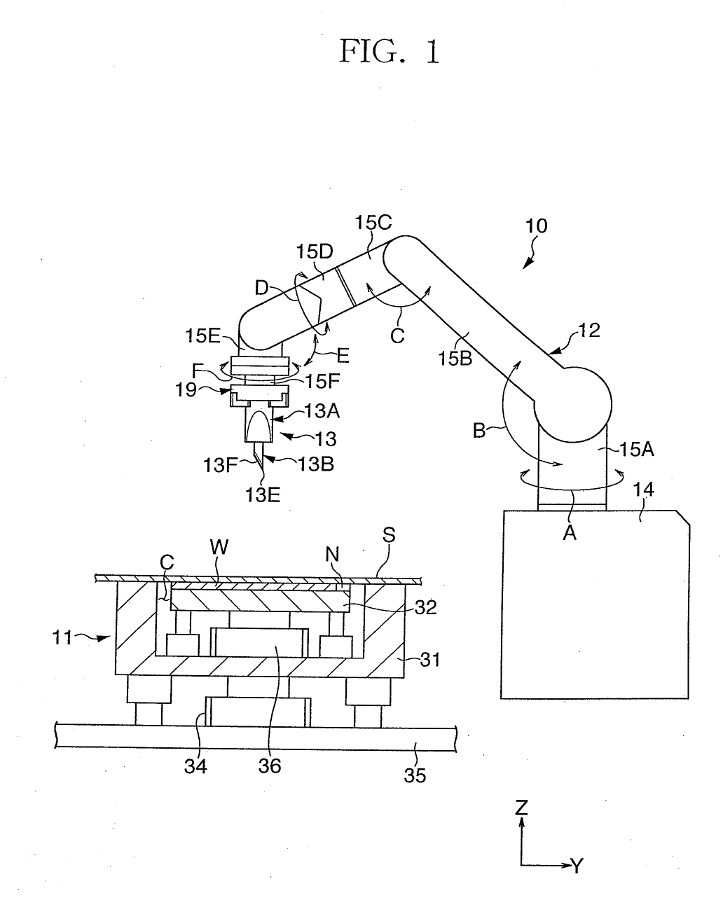

FIG. 1 is a front view schematically showing a sheet cutting device 10, to which a cutting method according to the present invention is applied, and a table 11 located beside the sheet cutting device 10 for supporting a wafer W as an object to stick a sheet S onto an upper surface of the wafer W. In this Figure, the sheet cutting device 10 comprises a robot body 12 as a cutting robot and a cutter blade 13 supported on the free-end side of the robot body 12. The robot body 12 includes a base section 14, first to sixth arms 15A to 15F, which are disposed on the upper surface side of the base section 14 so as to be rotatable in the directions indicated with arrows A to F respectively, and a tool holding chuck 19 attached to the front end side of the sixth arm 15F; i.e., on the free-end side of the robot body 12. Each of the second, third and fifth arms 15B, 15C, 15E is provided rotatably within a Y×Z plane in FIG. 1; and each of the first, fourth and sixth arms 15A, 15D, 15F is provided rotatably about the axis thereof. Here, a displacement mechanism for changing insertion depth of the cutter blade 13 is arranged by means of the first to sixth arms 15A to 15F. It should be noted that the sheet cutting device 10 in this embodiment is controlled by numerical (numerical controlled: NC), and the cutter blade 13 is adapted to escape to an outer position out of an upper area of the table 11; i.e., to a side position of the table 11 while the cutter blade 13 is out of cutting operation.

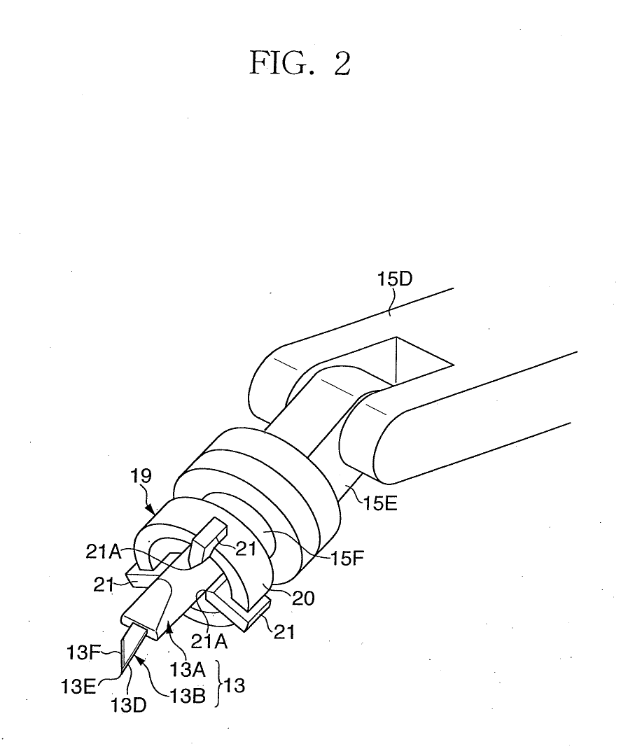

As shown in FIG. 2, the tool holding chuck 19 comprises a cutter blade receiver 20 having a substantially cylindrical shape and three chuck claws 21 disposed at positions substantially 120° away from each other in the peripheral direction of the cutter blade receiver 20, which detachably holds the cutter blade 13. Each of the chuck claws 21 has a pointed-edge portion 21A, inner end of which forms an acute angle, and is arranged so as to move forward/backward in the radial direction with respect to the center of the cutter blade receiver 20 by pneumatic pressure.

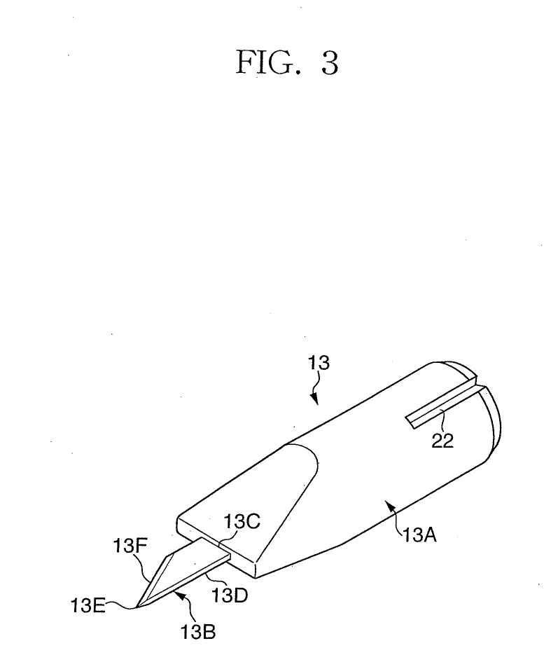

As shown in FIG. 3, the cutter blade 13 comprises a blade holder 13A constituting a base portion and a blade 13B inserted into the front end of the blade holder 13A and fixed thereto. The blade holder 13A has a substantially cylindrical shape, and at the positions substantially 120° away from each other in the peripheral direction of the circumferential surface thereof, grooves 22 having a length extending from the base end to an intermediate portion thereof are formed along the axial direction. The pointed-edge portions 21A of the chuck claws 21 are arranged to engage with these grooves 22, and thereby the position of the cutter blade 13 with respect to the tool holding chuck 19 is maintained to be constant.

The blade holder 13A is equipped with a heater (not shown) and a vibrating device (not shown) therein, and is arranged so as to heat the blade 13B with the heater as well as to vibrate the blade 13B with the vibrating device. As the heater, a coil heater can be exemplified; and as the vibrating device, an ultrasonic vibrating device can be exemplified.

As shown in FIG. 3, a blade 13B includes a base portion 13C supported by the blade holder 13A, a back portion 13D along an axial line of the blade holder 13A and a blade edge 13F extending at a sharp angle from the front end portion 13E of the back portion 13D. Accordingly, the blade edge 13F has such a shape that the width at the front end portion 13E side is smaller than the width at the base portion 13C side.

As shown in FIG. 1, the table 11 comprises: an outer table 31 having a substantially square shape in plane view; and an inner table 32 having a substantially circular shape in plane view. The outer table 31 is configured in a concave-shape so as to receive the inner table 32 in a state that a gap C is formed between the outer edge of the inner table 32 and the outer table 31, and is arranged so as to move in the vertical direction with respect to the base 35 via a uniaxial robot 34. On the other hand, the inner table 32 is arranged so as to move in the vertical direction with respect to the outer table 31 via a uniaxial robot 36. Accordingly, the outer table 31 and the inner table 32 are arranged so as to move integrally in the vertical direction as well as to move in the vertical direction independently each other. Owing to this, the outer table 31 and the inner table 32 are arranged to be adjustable to a predetermined level position corresponding to the thickness of the adhesive sheet S and the wafer W. The inner table 32 has a substantially disk-like shape, which is formed to a plane size substantially corresponding to a plane size of the wafer W, but does not have a notch corresponding to a notch (described latter) formed in the outer circumferential portion of the wafer W.

It should be noted that, although being omitted in FIG. 1, there are disposed in an area above the table 11 with a sheet feed-out unit, which feeds out a sheet S onto the wafer W, and a sticking roller, which rotates and moves in contact with the upper surface side of the sheet S fed out onto the wafer W to stick the sheet S to the wafer W.

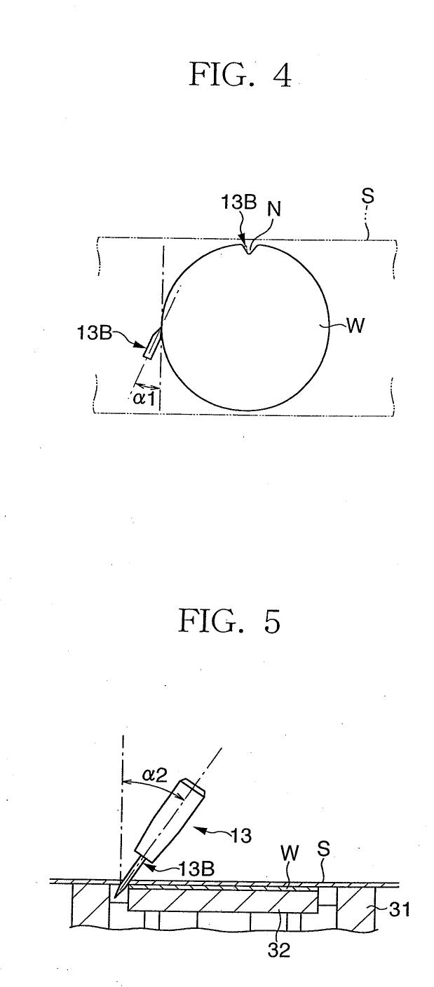

Next, a cutting method of the sheet S according to the embodiment will be described with reference to FIGS. 4 to 7 as well. It should be noted that the sheet S is stuck onto the wafer W in a manner disclosed in Japanese Patent Application Laid-Open No. 2005-198806. Also, it should be noted that, as shown in FIG. 4, the wafer W, which is formed with a notch N having a substantially V-shape indicating a crystal orientation thereof as a specific area in an outer circumferential portion, is the object to be stuck with the sheet S, and is placed so that the notch N is disposed to a predetermined position on the inner table 32 via an alignment device (not shown).

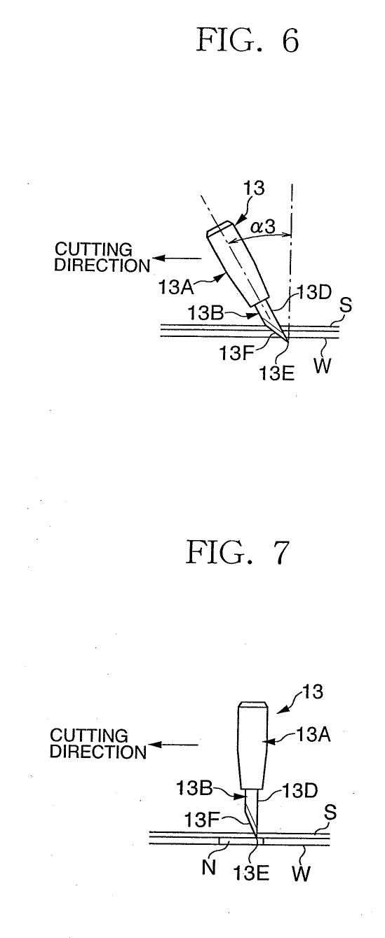

As the initial settings, external dimensions of the wafer, a toe-in angle α1 with which the center line of the cutter blade 13 is inclined with respect to the cutting direction viewed from the top in the cutting direction as shown in FIG. 4, a camber angle α2 with which the center line of the cutter blade 13 is inclined viewed from the front side in the cutting direction as shown in FIG. 5, and a caster angle α3 with which the center line of the cutter blade 13 is inclined with respect to the cutting direction viewed from the side in the cutting direction as shown in FIG. 6 are inputted through an inputting device (not shown). The reason of provision of the toe-in angle α1, camber angle α2 and caster angle α3 is to prevent the sheet S from remaining out of the outer edge of the wafer W after the sheet S has been cut off, and to facilitate the cutting of the sheet.

The robot body 12 is arranged to perform a predetermined operation to move the cutting device 10 so that the cutter blade 13 is retained at a retired side position of the table 11 during a sticking operation of the adhesive sheet S to the wafer W; and moves, after the adhesive sheet S is stuck to the upper surface of the wafer W, to a position above the table 11.

Then, based on the data inputted through the inputting device, movement track data stored in a storage of the control device (not shown) are read out, and the blade 13B cuts the adhesive sheet S along the outer shape of the wafer while maintaining the toe-in angle α1, camber angle α2 and caster angle α3 (refer to FIGS. 4 to 6). Here, when the sheet S can be hardly cut at a room temperature, the blade 13B may be heated by the coil heater, or may be vibrated by the ultrasonic vibrating device. Owing to this, the adhesive sheet S can be cut matching with the outer periphery of the wafer W in a state that the cutting resistance is reduced to an extremely small level.

Here, when the sheet is cut along the outer edge of the wafer W using the displacement mechanism, to cut the area excluding the notch N area, the blade 13B is kept at the first position where the insertion depth of the blade 13B is deep as shown in FIG. 4 to FIG. 6. When the blade 13B reaches the notch N area marked with a double-dashed line in FIG. 4, the robot body 12 is controlled so that the blade 13B is kept at a second position where the insertion depth is shallower than that at the first position as shown in FIG. 7. And the sixth arm 15F rotates the blade 13B in a direction of arrow F to cut the sheet along the shape of the notch N in cooperation with the other arms 15A to 15E. The insertion depth of the blade 13B may be changed while cutting the sheet S or after suspending the cutting operation using the displacement mechanism. Moreover, the displacement mechanism is controlled so that, when cutting the sheet S at the first position, the front end portion 13E of the blade 13B is positioned below the upper surface of the inner table 32; and when cutting the sheet S at the second position, the front end portion 13E of the blade 13B is positioned above the upper surface of the inner table 32. Therefore, even when a notch corresponding to the notch N is not formed in the outer circumferential portion of the inner table 32, since the front end portion 13E does not come into contact with the inner table 32, the blade 13 is prevented from breakage and the like. However, when a wafer W of several dozens of μm in thickness after grinding the rear surface is handled as the object, it is preferred to form a notch corresponding to the notch N in the outer circumferential portion of the inner table 32.

When the cutting operation of the sheet S is completed, the sheet cutting device 10 removes the cutter blade 13B from the tool holding chuck 19 to exchange the cutter blade 13B with a suction arm (not shown) in order to temporarily function as a transfer device. And the cutting device 10 supporting the suction arm, sucks and transfers the wafer W after cutting off the sheet S to a next process; and transfers a new wafer W to be stuck with the sheet S from a wafer stocker (not shown) onto the table 11. After transferring the wafer W, the sheet cutting device 10 stores the suction arm into a predetermined stocker, and mounts the cutter blade 13 onto the tool holding chuck 19 again to prepare for the next cutting operation.

When the wafer W is removed from the table 11, a peeling device (not shown) winds an unnecessary adhesive sheet, which is left around the wafer W. The winding operation is substantially same as the operation disclosed in Japanese Patent Application Laid-Open No. 2005-198806.

Therefore, according to the embodiment described above, the following effects can be obtained; i.e., the sheet S stuck on the wafer W can be cut off precisely along the wafer outer edge, and even when an object having a plane shape with various complicated portion is to be handled as a object, the sheet cutting operation can be carried out continuously.

The best arrangement and method for carrying out the present invention have been disclosed so far. However, the present invention is not limited to the above.

That is, the present invention has been illustrated and described mainly about a specific embodiment. However, it is possible for those skilled in the art to add various modifications, if necessary, to the above-described embodiment with respect to the shape, position and/or disposition without departing from the technical spirit and the range of the object of the present invention.

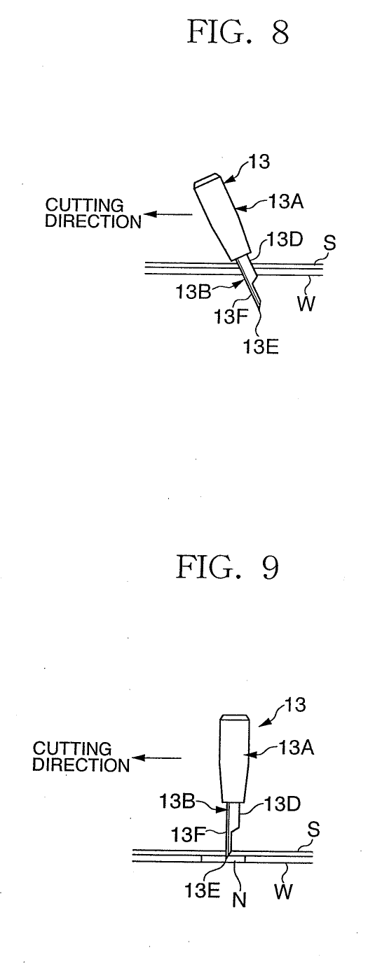

For example, a cutter blade 13B having such a shape that the blade width at the front-end side is different from that at the base side as shown in FIG. 8 and FIG. 9, may be used. The cutter blade 13B shown in FIG. 8 and FIG. 9 is arranged so that the blade width at the front-end side is smaller with respect to the blade width at the base side. A sheet cutting operation using this cutter blade 13B is arranged so that the area of the sheet S other than the notch N area is cut using an area having a larger blade width, and the area of the sheet S in the notch N area is cut using an area having a smaller blade width.

Basically, the present invention can work sufficiently simply when such an arrangement is prepared that, when cutting the sheet in an extremely small area such as the notch N or in a complicated area, the cutter blade 13B is allowed to move flexibly to cut the sheet S smoothly.

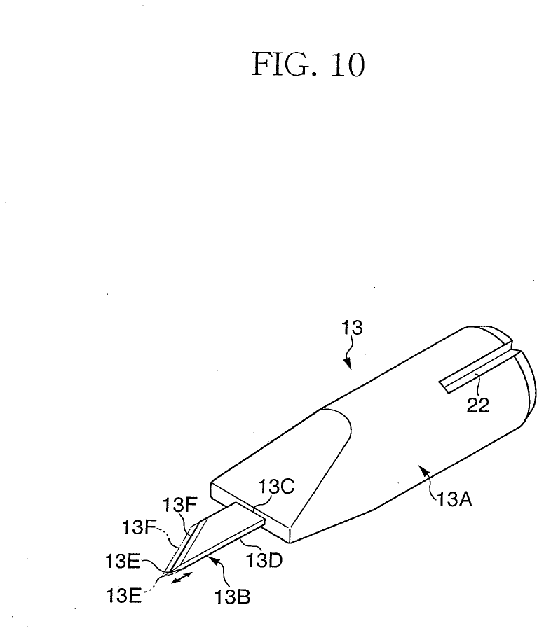

Also, in the above-described embodiment, the displacement mechanism for changing the insertion depth of the cutter blade is composed of the first to sixth arms 15A to 15F on the robot body 12. However, the blade holder 13A may include displacement mechanism so that the cutter blade 13B moves forward and backward with respect to the blade holder 13A as shown in FIG. 10.

1. A sheet cutting device for cutting a sheet stuck on an object in accordance with a plane shape of said object, comprising:
a support table for supporting said object;
a cutting robot equipped with a cutter blade at a free-end side for cutting said sheet by moving said cutter blade along a predetermined track; and
a displacement mechanism for changing an insertion depth of said cutter blade, wherein said cutter blade cuts said sheet by changing the insertion depth via said displacement mechanism when cutting a predetermined specific area corresponding to said object.

2. The sheet cutting device according to claim 1, wherein said cutting robot is a multi-joint robot having a plurality of joints numerically controlled to function as said displacement mechanism.

3. The sheet cutting device according to claim 1, wherein said cutter blade includes a blade holder and a blade supported by said blade holder, said blade holder being equipped with said displacement mechanism arranged so as to be capable of displacing said blade in a direction where the insertion depth is changed.

4. A sheet cutting method of cutting a sheet stuck on an object in accordance with a plane shape of said object, in which
using a cutting robot having a cutter blade mounted on a free-end side thereof, wherein
said cutter blade cuts said sheet by means of changing an insertion depth of said cutter blade when cutting a predetermined specific area corresponding to said object.

5. A sheet cutting method of cutting a sheet stuck on a semiconductor wafer having a notch in an outer circumferential portion in accordance with a plane shape of said semiconductor wafer, in which
using a cutting robot having a cutter blade mounted on a free-end side thereof, wherein
said cutter blade cuts said sheet at a first insertion depth when cutting said sheet along an outer edge of said wafer other than an edge formed with said notch, and cuts said sheet at a second insertion depth shallower than said first insertion depth when cutting said sheet along an edge formed with said notch.

6. The sheet cutting method according to claim 4, wherein said cutting operation is continuously carried out along a track having a substantially closed loop without pulling out and reinstalling said cutter blade.
